(19) United States
(12) Patent Application Publication
(10) Pub. No.: US 2011/0186330 A1
(43) Pub. Date: Aug. 4, 2011

(54) CERAMISABLE COMPOSITION FOR A POWER AND/OR TELECOMMUNICATION CABLE

(75) Inventors: Christelle Mazel, Ruy (FR); Arnaud Piechaczyk, Lyon (FR); Roland Avril, Lyon (FR); Stéphanie Hoareau, Givors (FR); Melek Kirli, Lyon (FR); Elisabeth Tavard, Autun (FR)

(73) Assignee: NEXANS, Paris (FR)

(21) Appl. No.: 13/055,047

(22) PCT Filed: Jul. 16, 2009
(86) PCT No.: PCT/FR2009/051423

§ 371 Date: Apr. 21, 2011

(30) Foreign Application Priority Data
Jul. 28, 2008 (FR) 0855147

(51) Int. Cl. H01B 7/29

(52) U.S. Cl. 174/121 A

(57) ABSTRACT

The present invention relates to a power and/or telecommunication cable comprising at least one conductive element surrounded by at least one insulating layer extending along the cable, the isolating layer being obtained from a composition containing the following compounds: a) an organic polymer; b) an inorganic compound containing a potassium oxide and/or one of the precursors thereof; c) a boron oxide and/or one of the precursors thereof; and d) calcium oxide CaO and/or one of the precursors thereof, characterized in that the amount of the compound d is at least 10 wt % of the total weight of the compounds b, c, and d in the composition.

The present invention relates to a power and/or telecommunications cable comprising at least one electrically insulating layer, which is also capable of withstanding extreme thermal conditions.

It applies typically, but not exclusively, to safety cables, i.e. power or telecommunications cables intended to remain operational for a definite period of time when they are subjected to strong heat and/or directly to fire.

At the present time, one of the major challenges of the cable industry is that of improving the behavior and performance of cables under extreme thermal conditions, especially those encountered during a fire. For essentially safety reasons, it is indeed indispensible to maximize the capacities of the cable for retarding the propagation of flames, on the one hand, and for withstanding fire, on the other hand, in order to ensure continuity of function.

A significant slowing-down of the progress of flames gains valuable time for evacuating premises and/or for implementing appropriate extinguishing means. In the event of a fire, the cable must be able to withstand the fire in order to function for as long as possible and to limit its degradation. A safety cable must also not be hazardous to its environment, i.e. it should not give off toxic and/or excessively opaque fumes when it is subjected to extreme thermal conditions.

Whether it is electrical or optical, intended for power or data transmission, a cable is schematically formed from at least one electrical or optical conductive element, surrounded by at least one electrically insulating layer.

By way of example, the electrically insulating layer may be insulation that is directly in contact with at least one conductive element of the cable. It may also be a protective sheath surrounding one or more insulated conductive elements.

A known composition of insulating layer for a cable, which can withstand fire, is described in document WO 2004/035 711. This composition comprises an organic polymer and several inorganic fillers which may especially be mica, zinc borate and metal oxides such as calcium, iron, magnesium, aluminum, zirconium, zinc, tin or barium oxides.

However, this type of composition cannot ensure mechanical and electrical integrity of the cable, i.e. its continued optimal functioning in the event of a fire.

The object of the present invention is to overcome the drawbacks of the solutions of the prior art by especially offering a cable comprising an insulating layer that affords an optimal compromise between its electrical insulation and mechanical strength properties under extreme thermal conditions.

The solution according to the present invention is to propose a power and/or telecommunications cable comprising at least one conductive element surrounded by at least one insulating layer, especially an electrically insulating layer, extending along the length of the cable, the insulating layer being obtained from a composition comprising the following compounds:

a) an organic polymer,

b) an inorganic compound comprising a potassium oxide and/or a precursor thereof,

c) a boron oxide and/or a precursor thereof, and

d) calcium oxide CaO and/or a precursor thereof, characterized in that the amount of compound d is at least 10% by weight and preferably at least 20% by weight relative to the total weight of compounds b, c and d in the composition.

This combination of inorganic fillers (compounds b, c and d) is optimally adapted to react under the conditions of a fire and thus to form a refractory ceramic compound: the insulating layer is said to be ceramisable.

Advantageously, the cable according to the present invention especially satisfies standards IEC 60331 part 21 or 23, DIN 4102 part 12 and EN 50200.

The term “metal oxide×precursor” (cf. potassium oxide, boron oxide or calcium oxide precursor) means any inorganic element that is capable of forming said metal oxide×under the action of a rise in temperature. Notably, said inorganic element forms the metal oxide at a temperature T below the temperature Tc of (start of) ceramisation of the insulating layer.

Ceramisation conventionally corresponds to consolidation via the action of heat of a more or less compact granular aggregate (particles), with or without fusion of one of the constituents. It typically comprises three successive steps, namely:
i. rearrangement and bonding of the particles,
ii. densification and removal of the intergranular porosities, and
iii. enlargement of the grains and gradual removal of the closed porosities.

The ceramisation start temperature is considered as being the temperature that is sufficient to observe the rearrangement and bonding of the particles mentioned in step i above.

Compound a

The nature of the organic polymer of the composition according to the present invention is in no way limiting.

This may be any type of organic polymer well known to those skilled in the art, especially capable of being extruded, of the thermoplastic polymer or elastomer type.

Needless to say, the organic polymer may be a mixture of several organic polymers, or may be a mixture of polymers formed from at least one organic polymer that is predominant in the mixture and from at least one other polymer of different nature.

The organic polymer is preferably chosen from an olefin polymer, an acrylate or methacrylate polymer, a vinyl polymer, and a fluoro polymer, or a mixture thereof.

The olefin polymer is especially chosen from an ethylene homopolymer or copolymer, and a propylene homopolymer or copolymer, or a mixture thereof.

As preferred examples, the olefin polymer is chosen from an ethylene homopolymer, an ethylene-octene copolymer (PEO), a copolymer of ethylene and vinyl acetate (EVA), an ethylene propylene diene monomer (EPDM) copolymer, a copolymer of ethylene and methyl acrylate (EMA), a copolymer of ethylene and butyl acrylate (EBA), and a copolymer of ethylene and ethyl acrylate (EEA), or a mixture thereof.

Compound b

Compound b may advantageously be a potassium oxide per se or a phyllosilicate comprising a potassium oxide. More particularly, the phyllosilicate comprising a potassium oxide is preferentially an aluminum phyllosilicate comprising a potassium oxide.

The potassium oxide preferably has the following chemical formula: K₂O. Other types of potassium oxide, for instance complex oxides, or in other words polyoxometallates, may also be considered in the context of the invention.

Phyllosilicates comprising a potassium oxide may be certain types of mica such as aluminoceladonite, boromuscovite, celadonite, chromphyllite, ferro-aluminoceladonite, ferrocelatonite, muscovite, roscoelite, annite, biotite, eastonite, hendricksite, lepidolite, masutomilite, montdorite, norrishite, polylithionite, phlogopite, siderophyllite, tainiolite, tetra-ferri-annite, tetra-ferriphlogopite, trilithionite, zinnwaldite, anadite, glauconite or illite micas.

Aluminum phyllosilicates comprising a potassium oxide such as aluminoceladonite, chromphyllite, ferro-aluminoceladonite, muscovite, roscoelite, annite, biotite, eastonite, hendricksite, lepidolite, masutomilite, montdorite, polylithionite, phlogopite, siderophyllite, trilithionite, zinnwaldite, anadite, glauconite or illite micas will be preferred.

In aluminum phyllosilicates comprising a potassium oxide, the muscovite mica of chemical formula 6SiO₂-3Al₂O₃—K₂O-2H₂O or the phlogopite mica of chemical formula 6SiO₂—Al₂O₃—K₂O-6MgO-2H₂O will be preferred.

The amount of compound b may be at least two parts by weight, preferably at least three parts by weight and even more preferentially at least six parts by weight per 100 parts by weight of polymer(s) in the composition.

Moreover, the amount of compound b may be at least 2% by weight, preferably at least 5% by weight and even more preferentially at least 10% by weight relative to the total weight of compounds b, c and d in the composition.

Compound c

The boron oxide may typically have the following formula: B₂O₃. However, B₂O₃ does not exist in this form in the free state. As a result, a boron oxide precursor is generally used.

The boron oxide precursor may be chosen, for example, from zinc borate, boron phosphate, boric acid, calcium borate (e.g. colemanite of chemical formula Ca₂B₆O₁₁.5H₂O) and sodium borate (e.g. borax of chemical formula Na₂B₄O₇.10H₂O).

The boron oxide precursor is preferably dehydrated, especially when said precursor is zinc borate, in order to avoid dehydration of said precursor when the insulating layer is subjected to fire, and thus disrupt the dimensional stability of the formed ceramic.

The amount of compound c may be at least 20 parts by weight and preferably at least 25 parts by weight per 100 parts by weight of polymer(s) in the composition.

Moreover, the amount of compound c may be at least 10% by weight, preferably at least 15% by weight and more preferentially at least 20% by weight relative to the total weight of compounds b, c and d in the composition.

Compound d

One of the calcium oxide CaO precursors may be calcium carbonate. Between calcium oxide, a calcium oxide precursor and the mixture of calcium oxide and calcium oxide precursor, calcium oxide per se is preferred.

The amount of compound d may advantageously be at least 10 parts by weight, preferably at least 20 parts by weight and even more preferentially at least 25 parts by weight per 100 parts by weight of polymer(s) in the composition.

Moreover, the amount of compound d may itself advantageously be at least 15% by weight and preferably at least 20% by weight relative to the total weight of compounds b, c and d in the composition.

Particular Embodiment: Compound b is Mica

Potassium oxide is present in certain types of mica as mentioned above. During the use of mica as compound b, the amount of compound b may be at least 40% by weight relative to the total weight of compounds b, c and d in the composition.

Preferably, the composition may comprise an amount of compound b of not more than 80% by weight, an amount of compound c of not more than 30% by weight, and an amount of compound d of not more than 50% by weight, said amounts being defined relative to the total weight of compounds b, c and d in the composition.

To summarize, and according to this embodiment, the composition may thus comprise an amount of compound b of from 40% to 80% by weight, an amount of compound c of from 10% to 30% by weight and an amount of compound d of from 10% to 50% by weight, said amounts being defined relative to the total weight of compounds b, c and d in the composition.

According to one preferred implementation example, the composition comprises an amount of compound b of 60% by weight, an amount of compound c of 20% by weight and an amount of compound d of 20% by weight, the said amounts being defined relative to the total weight of compounds b, c and d in the composition.

Other Inorganic Fillers

The composition according to the present invention may also comprise other inorganic fillers of the nanoparticle type.

At least one of the dimensions of said nanoparticles is typically of nanometric size (10⁻⁹ meter). More particularly, the average size of the mineral nanoparticles is not more than 400 nm, preferably not more than 300 nm and more preferentially not more than 100 nm.

The average size of the nanoparticles is conventionally determined via methods that are well known to those skilled in the art, for instance laser granulometry or microscopy techniques, especially SEM (Scanning Electron Microscopy) or TEM (Transmission Electron Microscopy).

These nanoparticles preferably have a shape factor of at least 100, the shape factor being the ratio of the largest dimension of a mineral nanoparticle to the smallest dimension of said nanoparticle.

Preferably, the nanoparticles are phyllosilicates chosen especially from montmorillonites, sepiolites, illites, attapulgites, talcs and kaolins, or a mixture thereof.

In order to provide an “HFFR” (Halogen-Free Flame Retardant) insulating layer, the composition does not comprise any halogenated inorganic fillers. The composition may also not comprise any halogenated polymers, for instance fluoro polymers or chloro polymers such as polyvinyl chloride (PVC).

The amounts of inorganic fillers in the composition (compounds b, c and d, and also optionally other inorganic fillers) may be defined such that the composition comprises at least 20 parts by weight, preferably at least 40 parts by weight, preferably at least 60 parts by weight and even more preferentially at least 90 parts by weight of inorganic fillers per 100 parts by weight of polymer(s).

The lower limit of 90 parts by weight is especially taken into account when compound b is mica (i.e. phyllosilicate comprising a potassium oxide).

Preferably, the composition comprises not more than 200 parts by weight of inorganic fillers per 100 parts by weight of polymer(s), so as to limit the rheology problems in the composition.

According to one particular feature of the present invention, the composition may be crosslinked so as to obtain a crosslinked insulating layer. The crosslinking of the composition may be performed via the standard crosslinking techniques that are well known to those skilled in the art, for instance silane crosslinking in the presence of a crosslinking agent, peroxide crosslinking under the action of heat, or photochemical crosslinking such as irradiation with beta radiation, or irradiation with ultraviolet radiation in the presence of a photoinitiator.

Other characteristics and advantages of the present invention will emerge in the light of the examples that follow with reference to the annotated figures, said examples and figures being given as illustrations that are not in any way limiting.

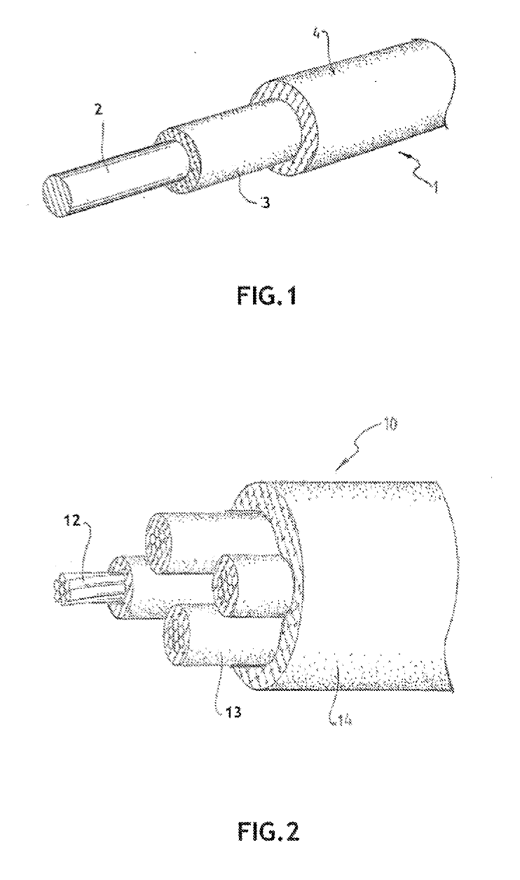

FIG. 1 schematically shows a perspective in cross section of an electrical cable having at least one insulating layer in accordance with the invention.

FIG. 2 schematically shows a perspective in cross section of another electrical cable having at least one insulating layer in accordance with the invention.

For reasons of clarity, only the elements that are essential for the understanding of the invention have been schematically represented, and have not been drawn to scale.

In a first implementation example, FIG. 1 shows an electrical cable 1 comprising a conductive element 2 of bulk type, surrounded by an insulating layer of the insulation type 3 directly in contact with the conductive element, said element itself being surrounded by an insulating layer of the protective sheath type 4.

In a second implementation example, FIG. 2 also shows an electrical cable 10 comprising at least two conductive elements 12 of multistrand type. Each multistrand 12 is surrounded by an insulating layer of the insulation type 13 directly in contact with the conductive element, these combined insulated multistrands being surrounded by an insulating layer of the protective sheath type 14.

Whether it is in FIG. 1 or 2, the insulating layer 3, 13 and/or the protective sheath 4, 14 may be obtained from the composition according to the present invention.

Typically, the insulation 3, 13 has a thickness of 0.6 to 2.4 mm and the protective sheath 4, 14 has a thickness of 1 to 2.5 mm.

The composition according to the invention is conventionally formed by extrusion around the conductive element(s) to form the insulation 3, 13 and/or the protective sheath 4, 14.

The extrusion of said composition may be compression or tamping extrusion, or tube extrusion.

Tube extrusion makes it possible to obtain an insulating tube layer, i.e. a layer in the form of a tube of a certain thickness, the inner surface and outer surface of which are, respectively, two substantially concentric cylinders.

Thus, the insulating tube layer does not fill the interstices between the conductive elements (insulated or not) and thus produces empty spaces between itself and the insulated or uninsulated conductive elements it surrounds; the empty spaces especially occupy at least 10% of the cross section of the cable.

In certain embodiments, the insulating layer leaves the conductive elements free inside said layer.

Tamping extrusion makes it possible to obtain a tamping layer, i.e. a layer that fills the interstices between the conductive elements (insulated or not), whose volumes are accessible, and thus said layer is directly in contact with the insulated or uninsulated conductive elements.

### EXAMPLES

Various insulating layers according to the present invention and according to the prior art were prepared in order to show the maintenance of the electrical integrity of said layers during fire resistance tests.

To do this, tables 1a and 1b below detail the compositions used to obtain said insulating layers.

It should be noted that the amounts mentioned in tables 1a and 1b are conventionally expressed in parts by weight per one hundred parts by weight of polymer(s) (phr).

TABLE 1a

| Compositions | A1 | A2 | A3 | B1 | B2 | B3 | B4 | C1 | C2 | C3 |
|---|---|---|---|---|---|---|---|---|---|---|
| EVA 28 | 100 | / | 20 | / | / | / | / | 50 | 57.5 | / |
| Grafted EVA 28 | / | / | / | / | / | 30 | 30 | / | / | / |
| 1.5% silane | | | | | | | | | | |
| Grafted EVA 40 | / | / | / | / | / | 70 | 70 | / | / | / |
| 1.5% silane | | | | | | | | | | |
| PEO | / | 100 | 70 | / | / | / | / | / | / | 55 |
| Grafted PEO | / | / | / | 50 | / | / | / | / | / | / |
| 1.2% silane | | | | | | | | | | |
| Grafted PEO | / | / | / | / | 100 | / | / | / | / | / |
| 2% silane | | | | | | | | | | |
| EPDM | / | / | / | / | / | / | / | 50 | 37.5 | 25 |
| Grafted EPDM | / | / | / | 50 | / | / | / | / | / | / |
| 1.5% silane | | | | | | | | | | |
| MA-grafted EVA | / | / | / | / | / | / | / | / | 5 | / |
| MA-grafted | / | / | 10 | / | / | / | / | / | / | / |
| LLDPE | | | | | | | | | | |
| EMA | / | / | / | / | / | / | / | / | / | 20 |
| Zinc borate | 30 | 30 | 26 | 30 | 30 | 30 | 25 | 30 | 30 | 30 |
| Mica 1 | 90 | 90 | 78 | 90 | 90 | 90 | 75 | 90 | 90 | 90 |
| Calcium oxide | 30 | 30 | 26 | 30 | 30 | 30 | 25 | 30 | 30 | 30 |
| Phyllo- | / | / | 20 | 20 | / | / | / | 20 | 20 | 20 |
| silicates 100 | | | | | | | | | | |
| Peroxide | / | / | / | / | / | / | / | 6 | 6 | 4.5 |

TABLE 1b

| Compositions | A4 | A5 | A6 |
|---|---|---|---|
| PEO | 100 | 100 | 100 |
| Zinc borate | 30 | 30 | 30 |
| Mica 2 | 90 | / | / |
| Phyllo- | / | 90 | / |
| silicate 1 | | | |
| Phyllo- | / | / | 90 |
| silicate 2 | | | |
| Calcium oxide | 30 | 30 | 30 |

The origin of the various constituents of tables 1a and 1b is as follows:

EVA 28 is an ethylene-vinyl acetate copolymer comprising 28% of vinyl acetate groups, sold by the company Arkema under the reference Evatane 2803;

EVA 28 grafted with 1.5% silane is an ethylene-vinyl acetate copolymer comprising 28% of vinyl acetate groups, sold by the company Arkema under the reference Evatane 2803, this copolymer having then been silane-grafted with 1.5% of a silane crosslinking agent (see details below);

EVA 40 grafted with 1.5% silane is an ethylene-vinyl acetate copolymer comprising 40% of vinyl acetate groups, sold by the company Arkema under the reference Evatane 2803, this copolymer having then been silane-grafted with 1.5% of a silane crosslinking agent (see details below);

PEO is an ethylene-octene copolymer sold by the company Dow under the reference Engage 8003;

PEO grafted with 1.2% silane is an ethylene-octene copolymer sold by the company Dow under the reference Engage 8003, this copolymer having then been silane-grafted with 1.2% of a silane crosslinking agent (see details below);

PEO grafted with 2% silane is an ethylene-octene copolymer sold by the company Dow under the reference Engage 8003, this copolymer having then been silane-grafted with 2% of a silane crosslinking agent (see details below);

EPDM is an ethylene-propylene-diene monomer copolymer sold by the company Dow under the reference Nordel 4725;

EPDM grafted with 1.5% silane is an ethylene-propylene-diene monomer copolymer sold by the company Dow under the reference Nordel 4725, this copolymer having then been silane-grafted with 1.5% of a silane crosslinking agent (see details below);

MA-grafted EVA is an ethylene-vinyl acetate copolymer grafted with maleic anhydride, sold by the company Arkema under the reference Orevac 18211;

MA-grafted LLDPE is a linear low-density ethylene homopolymer grafted with maleic anhydride, sold by the company Arkema under the reference Orevac 18302;

EMA is an ethylene-methyl acrylate copolymer sold by the Company Arkema under the reference Lotryl 24 MA 005;

Zinc borate is dehydrated zinc borate sold by the company Rio Tinto Minerals under the reference Fire brake 500;

Mica 1 is mica of muscovite type sold by the company Microfine under the reference Mica sx300; Mica 1 comprises 7% to 10% by weight of K₂O;

Mica 2 is mica sold by the company Imerys under the reference Mica Mu M2/1; Mica 2 comprises about 8.5% by weight of K₂O;

Phyllosilicate 1 is kaolinite sold by the company Imerys under the reference Argirec B24; phyllosilicate 1 does not comprise any K₂O;

Phyllosilicate 2 is aluminum phyllosilicates sold by the company Imerys under the reference Hexafil; phyllosilicate 2 comprises 2.3% to 3.2% by weight of K₂O;

Calcium oxide is calcium oxide CaO sold by the company Omya under the reference Caloxol PG;

Phyllosilicates 100 are montmorillonite nanoparticles sold by the company Rockwood under the reference Nanofil 5; phyllosilicates 100 do not comprise any potassium oxide;

Peroxide is dicumyl peroxide sold by the company Akzo Nobel under the reference Perkadox BC40 (dicumyl peroxide) or Perkadox 14/40 (1.3-bis(t-butylperoxyisopropyl)benzene).

The composition may also typically comprise additives in an amount from 5 to 20 phr. The additives are well known to those skilled in the art and may be chosen, for example, from protective agents (antioxidants, UV stabilizers, anti-copper agents), processing agents (plasticizers or lubricants), and pigments.

Preparation of Insulating Layers from Compositions A1 to A6 of Tables 1a and 1b

The polymer(s) in melt form are continuously mixed, with heating, with the various inorganic fillers detailed in tables 1a and 1b.

Mixing is performed using a Buss single-screw mixer or a twin-screw extruder, and the inorganic fillers are added to the polymer(s) using a standard metering hopper.

The mixture of the filler-charged polymer(s) is extruded directly on a bulk or multi-strand copper wire with a cross section of 1.5 mm², the extruded insulating layer having a thickness of 0.8 mm.

Preparation of Insulating Layers from Compositions B1, B2, B3 and B4 of Table 1a

In a first step, the polymers of table 1a in melt form are continuously mixed, with heating, with a silane crosslinking agent of the alkoxysilane or carboxysilane type together with an organic peroxide, using a Buss single-screw mixer or a twin-screw extruder.

The crosslinking agent is added in an amount of 1% to 2.5 and that used in compositions B1 to B4 is Silfin 59 sold by the company Evonik.

The temperature of the mixture of this first step is such that it typically allows the polymer mixture to be used while at the same time decomposing the organic peroxide.

This first step gives a mixture of silane-grafted polymers in the form of granules.

In a second step, the silane-grafted polymer in melt form is continuously mixed, with heating, with the various inorganic fillers detailed in table 1a.

The mixing is performed using another Buss single-screw mixer or another twin-screw extruder, and the inorganic fillers are added to the silane-grafted polymer using a standard metering hopper.

This second step gives a filler-charged silane-grafted polymer, the filler-charged silane-grafted polymer typically being obtained in the form of granules.

In a third step, the filler-charged silane-grafted polymer granules are used in melt form in a single-screw extruder in the presence of a catalyst for the condensation reaction of silanol groups, for instance dibutyltin dilaurate (DBTL), which is well known to those skilled in the art.

The catalyst is typically added to the filler-charged silane-grafted polymer in the form of a masterbatch based on a polyolefin that is compatible with said grafted polymer.

By way of example, the masterbatch containing said catalyst is added in an amount of about n by weight to the filler-charged silane-grafted polymer.

The mixture of the filler-charged silane-grafted polymer and of the silanol condensation catalyst is extruded directly on a multi-strand copper wire with a cross section of 1.5 mm², the extruded insulating layer having a thickness of 0.8 mm.

Preparation of Insulating Layers from Compositions C1, C2 and C2 of Table 1a

In a first step, the polymers in melt form are continuously mixed, with heating, with the various inorganic fillers and the peroxide detailed in table 1a.

The mixing is performed using a Buss single-screw mixer or a twin-screw extruder, and the inorganic fillers and peroxide are added to the polymer(s) using a standard metering hopper.

The mixture of the filler-charged polymer(s) is extruded directly on a bulk or multi-strand copper wire with a cross section of 1.5 mm², the extruded insulating layer having a thickness of 0.8 mm.

The mixing and extrusion temperature conditions are such that the temperature is sufficient to soften and homogenize the peroxide and the inorganic fillers in the polymer(s) while at the same time avoiding initiation of decomposition of the peroxide.

In a second step, the insulating layer thus formed is crosslinked via the peroxide route under the action of heat, in a salt bath, in a vapor tube or in a fluidized bed at atmospheric pressure or at a pressure close thereto.

### Fire Resistance Tests

The fire resistance tests are performed according to the following three standards: IEC 60331 part 21 or 23, DIN 4102 part 12, and EN 50200.

Standard IEC 60331 part 21 or 23 consists in subjecting an electrical cable to its nominal voltage when it is suspended horizontally over a flame of at least 750° C. for a given time but with no mechanical constraint.

During this period, the cable is checked to see whether there is any short-circuiting or rupture of the electrical conductors. The test is successful when there is neither any short-circuiting nor any rupture of the electrical conductors during the test and over the following 15 minutes. The electrical cable that satisfies the test for 30 minutes is then classified FE30. When it satisfies the test for 90 minutes or for 180 minutes, it is classified, respectively, as FE90 and FE180.

Standard DIN 4102 part 12 consists in subjecting an electrical cable with its fixing devices in an oven of minimum length 3 meters for a given time according to a standardized temperature curve (ISO 834).

Furthermore, the electrical cable and its fixing devices are subjected to the maximum admissible weight and to the prescribed loads. The electrical conductors, which are at their working voltage, should not break or give rise to short circuits.

This type of test similar to the reality of a fire concerns not only the electrical cable but also the systems for fixing said cable.

The electrical cable that satisfies the test for 30 minutes at 842° C. is then classified E30. When it satisfies the test for 60 minutes at 945° C. or for 90 minutes at 1006° C., it is then classified, respectively, as E60 and E90.

Standard EN 50200 consists in mounting and attaching with metal rings a U-shaped electrical cable on a plate of refractory material.

During the test, the electrical cable is subjected to a flame (850° C.) and also to a metallic impact delivered by a metal bar that falls onto the plate of refractory material every five minutes. The electrical conductors, which are at their working voltage, should not break or give rise to short circuits.

The electrical cable that satisfies the test for 15, 30, 60, 90 or 120 minutes is then classified, respectively, PH15, PH30, PH60, PH90 or PH120.

Table 2 below shows the very satisfactory results of the fire resistance tests on insulating layers of electrical cables according to the present invention. The electrical cables used for said tests are formed from at least two copper wires that are respectively, insulated, this assembly of insulated copper wires being surrounded by a standard protective sheath of HFFR type that is well known to those skilled in the art. The electrically insulating layers of the copper wires of each assembly are obtained, respectively, from compositions A1 to A3, B1 to B4 and C1 to C3.

TABLE 2

| Standards | IEC 60331 part 31 | EN 50200 | DIN 4102 |
|---|---|---|---|
| Results | FE 180 | PH 90 | E30 |

### Cohesion Tests

In order to characterize the cohesion (residual cohesion) of a material after combustion, the extruded insulating layers obtained, respectively, from compositions A2, A4, A5 and A6 were subjected to a mechanical penetration resistance test.

The procedure consists mainly in driving a penetrating member at constant speed into each combustion residue, and in concomitantly measuring, using a force sensor, the resistance of the burnt material as a function of the effective penetration depth.

The penetrating member is concretely in the form of a cylinder 6 mm in diameter and 20 mm long. In order to offer a convex contact surface, this cylinder is used in a position parallel to the outer surface of the residue to be tested, and with a travelling direction perpendicular to said outer surface. The penetration speed is set at 10 mm/min.

The cylindrical geometry of the penetrating member makes it possible simultaneously to quantify the compression resistance and the creep strength.

In practice, a compression machine of Zwick/Roel Z010® type is used to continuously perform series of resistance measurements, from which will be deduced each time the characteristic value of the residual cohesion, namely the maximum resistance force reached after having penetrated 50% of the thickness of the sample.

Table 3 below collates the characteristic residual cohesion values, noted Fmax-50%, expressed in newtons, for extruded insulating layers after combustion at 920° C.

TABLE 3

Extruded insulating layers obtained
from the following compositions:

| | A2 | A4 | A5 | A6 |
|---|---|---|---|---|
| Fmax-50% after | 231 | 338 | 125 | 215 |
| combustion at 920° C. | | | | |

In the light of the results of table 3, the insulating layer obtained from the compositions according to the invention (compositions A2, A4 and A6) shows excellent residual cohesion after having been subjected to combustion at 920° C.

In contrast, the residual cohesion result (125N after combustion at 920° C.) corresponding to the insulating layer obtained from composition A5 (composed, inter alia, of kaolinite, i.e. of a phyllosilicate not comprising potassium oxide) is far inferior to those obtained from the insulating layers of the invention.

Consequently, these results make it possible advantageously to show the existence of real synergism of action of the combination of compounds b, c and d on the measured parameter (i.e. the residual cohesion).

1. A power and/or telecommunications cable comprising:
at least one conductive element surrounded by at least one insulating layer that extends along the length of the cable, the insulating layer being obtained from a composition having the following compounds:
a) an organic polymer,
b) an inorganic compound having a potassium oxide and/or a precursor thereof,
c) a boron oxide and/or a precursor thereof, and
d) calcium oxide CaO and/or a precursor thereof, wherein the amount of compound d is at least 10% by weight relative to the total weight of compounds b, c and d in the composition.

2. The cable as claimed in claim 1, wherein the amount of compound b is at least two parts by weight per 100 parts by weight of polymer(s) in the composition.

3. The cable as claimed in claim 1, wherein the amount of compound b is at least 2% by weight relative to the total weight of compounds b, c and d in the composition.

4. The cable as claimed in claim 1, wherein the amount of compound c is at least 20 parts by weight per 100 parts by weight of polymer(s) in the composition.

5. The cable as claimed in claim 1, wherein the amount of compound c is at least 10% by weight relative to the total weight of compounds b, c and d in the composition.

6. The cable as claimed in claim 1, wherein the amount of compound d is at least 10 parts by weight per 100 parts by weight of polymer(s) in the composition.

7. The cable as claimed in claim 1, wherein compound b is a phyllosilicate having a potassium oxide.

8. The cable as claimed in claim 7, wherein compound b is a mica, preferably muscovite mica.

9. The cable as claimed in claim 7, wherein the amount of compound b is at least 40% by weight relative to the total weight of compounds b, c and d in the composition.

10. The cable as claimed in claim 7, wherein the composition comprises an amount of compound b of 40% to 80% by weight, an amount of compound c of 10% to 30% by weight and an amount of compound d of 10% to 50% by weight, said amounts being defined relative to the total weight of compounds b, c and d in the composition.

11. The cable as claimed in claim 7, wherein the composition comprises an amount of compound b of 60% by weight, an amount of compound c of 20% by weight and an amount of compound d of 20% by weight, said amounts being defined relative to the total weight of compounds b, c and d in the composition.

12. The cable as claimed in claim 1, wherein the boron oxide precursor is selected from the croup consisting of zinc borate, boron phosphate, boric acid, calcium borate and sodium borate.

13. The cable as claimed in claim 1, wherein the boron oxide precursor is dehydrated.

14. The cable as claimed in claim 1, wherein the calcium oxide precursor is calcium carbonate.

15. The cable as claimed in claim 1, wherein the composition is crosslinked.
